(19) United States
(12) Patent Application Publication
(10) Pub. No.: US 2011/0252611 A1
(43) Pub. Date: Oct. 20, 2011

(54) PORTABLE MULTIPOINT TENTER

(75) Inventor: MICHAEL G. LIPTON, Mountain View, CA (US)

(73) Assignee: Artificial Muscle, Inc., Sunnyvale, CA (US)

(21) Appl. No.: 13/088,714

(22) Filed: Apr. 18, 2011

Related U.S. Application Data
(60) Provisional application No. 61/325,479, filed on Apr. 19, 2010.

(51) Int. Cl. B29C 55/16; B29C 55/20

(52) U.S. Cl. 26/72

(57) ABSTRACT

The present invention provides portable multipoint tenter made from a rotating ring with a plurality of curved slots for placement in each of a first prong of a plurality of two-prong, guide pins, a circular base plate with a plurality of straight slots for placement of the first prong and a second prong of the plurality of two-prong guide pins and a contact pad attached to each of the second prongs. The inventive portable multipoint tenter helps to assure asymmetrical stzetch and is customizable so it can be made with various numbers of pads with minimal redesign. Because the inventive device is hand powered rather than electrical, the device is both portable and environmentally friendly.

### FIELD OF THE INVENTION

The present invention relates in general to devices and methods for stretching elastic films and more specifically to a portable multipoint tenter.

### BACKGROUND OF THE INVENTION

Those skilled in the art are aware of the difficulties of evenly stretching an elastic film to specific strains on a small-scale. Current devices found in the art are typically large stretching machines which take up large areas and are not mobile.

For example, U.S. Pat. No. 3,916,491, issued to Kampf, discloses a tenter clip type stretching machine for receiving and gripping thermoplastic films in an entering section having spaced apart tenter clips successively arranged along a processing section at each side of the film. The clips are each provided with a gap to retain a section of the marginal edge Of the filth, and a feeder means is disposed adjacent to the entering section for dispensing a channel-shaped edge cover strip into the gap of each tenter clip of the processing section so that the cover strip encompasses the respective marginal edge of the film as the tenter clip is ready to grip the film. The apparatus also includes a payoff device for receiving a supply spool to contain the cover strip, and a foldover device for folding the cover strip so that it has a channel configuration whereby the two legs of the channel protrude over the film edge. A registration means is also provided inside the feeder to align the cover strip between the gaps of the tenter clips. The cover strip is also subdivided into a plurality of individual sections by transversely extending perforations.

A second type of current art device relies on hand cranks with only a few points and a high chance of strain concentrations from due to the methodology involved. In addition, human error is a factor as these devices rely on visual rather than mechanical methods. Further, most tenters are uniaxial or biaxial, which may result in an uneven stretch or stress concentrations of the film and arc not fully portable as they generally require an electrical source, such as an outlet.

Therefore, a need exists in the art for a device providing even, symmetrical stretching of elastic films. Such a device should also be portable and not require a supply of electricity to operate.

### SUMMARY OF THE INVENTION

Accordingly, the present invention obviates problems inherent in the art by providing a portable multi-point tenter having an expanding circular configuration. The linking of each gripper pad to each other helps to assure a symmetrical stretch. In addition, the inventive portable multipoint tenter is customizable so it can be scaled in size or made with various numbers or types of pads with minimal redesign as well as different geometries of stretch to match the film and frame it is to be placed on after stretching. It can also be designed to provide anisotropic stretch ratios with an essentially uniform stress distribution. Because the inventive multi-point tenter is hand powered rather than electrical, the device is both portable and environmentally friendly.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIG. 1 shows the upper side of the inventive portable multipoint tenter with curved slots;

FIG. 2 depicts the underside of the inventive portable multipoint tenter with straight slots for guide pins;

FIG. 3 shows an exploded view of the portable multipoint tenter of the present invention with a rotating ring, base plate and a plurality of two-prong guide pins;

FIG. 4 is a photograph of the fully assembled portable multipoint tenter of the present invention with magnetic pads and wing nuts, in the open position; and

FIG. 5 provides a close up view of the inventive portable multipoint tenter.

### DETAILED DESCRIPTION OF THE INVENTION

The present invention will now be described for purposes of illustration and not limitation.

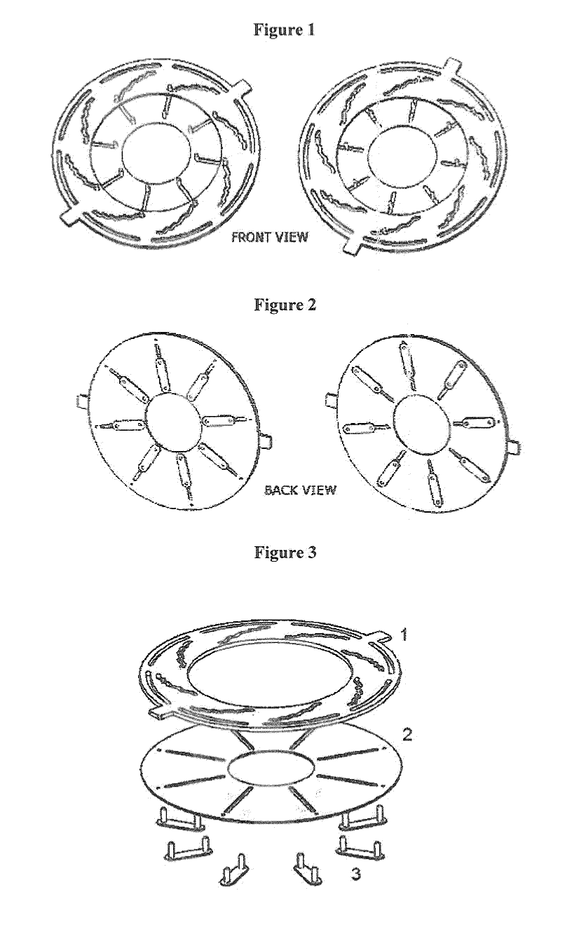

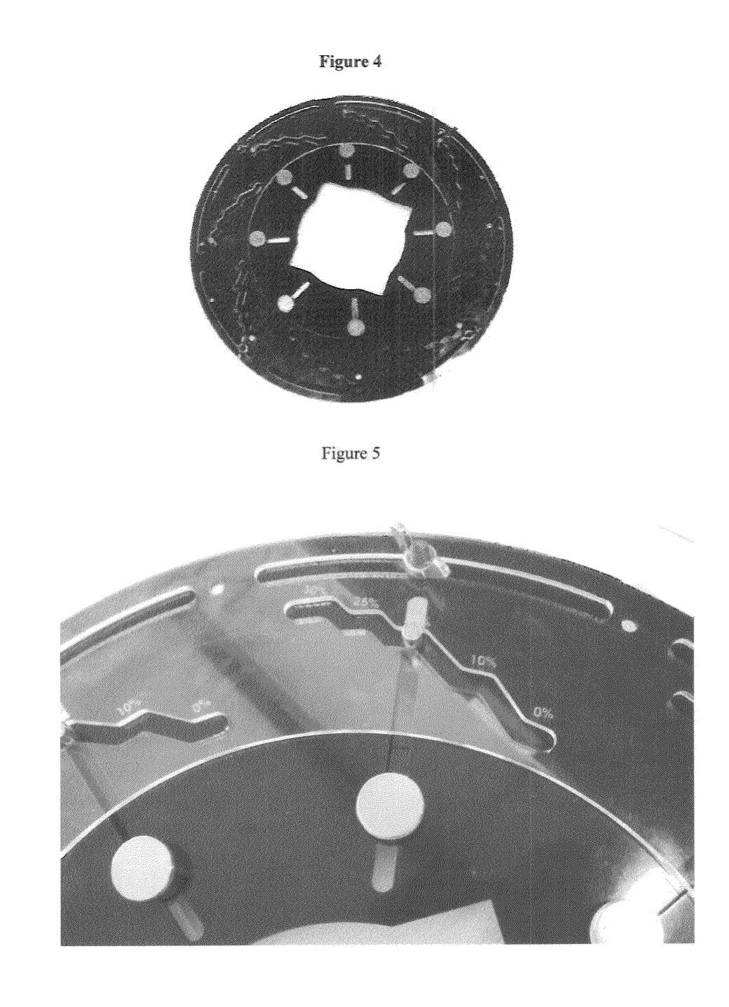

FIGS. 1-3, illustrate the basic mechanism of the inventive portable multipoint tenter, shown here without fasteners (preferably wing nuts or clamps) and contact pads. The portable multipoint tenter of the present invention contains a rotating ring with a plurality of curved slots for two-prong guide pins, a base plate with-s a plurality of straight slots for two-prong guide pins, and a plurality of two-prong guide pins. Preferably, at least one prong (nearest to the center) of each two-prong guide pin has a magnetic pad attached, the other prong of the two-prong guide pin mates with the rotating ring.

In the method according to the present invention, an elastic film preferably is stretched by being held between sets of pads placed in a circular formation. The film may be, physically held in place on the pads by a magnet on each side of the contact pads. Each pad is attached to a first prong of a two-prong guide pin which travels in a straight slot so as to control direction of movement. Each of the pads is attached through the two-prong guide pin, to a second prong away from the film to be stretched. This second prong of the two-prong guide pin travels through a rotating ring with curved slots, so that as the rotating ring turns, the first prong is forced to travel up the straight slots at even and specified distances. The curved slots preferably have markings to show the percent of strain obtained when the second prong has reached a given point. FIG. 5 provides a close up view of the inventive portable multipoint tenter showing the strain percent settings. A combination of fasteners, preferably threaded screws and wing nuts, may be used to hold the rotating ring in place after the desired stretch has been obtained. The film at this point is stretched and can be transferred to a rigid frame, and subsequently removed from the pads. Purely mechanical based stretching may be effected in this manner rather than requiring an operator to “eyeball” the film onto a frame during the stretching procedure. The portable multipoint tenter of present invention thereby results in fewer instances of operator error than with other prior art hand-powered devices.

The portable multipoint tenter works by a series of contact pads moving in unison away from each other to create a uniform stretch across a film placed upon the pads. The film may preferably be held in place both by, the tackiness of the film as well as magnets on the pads. Film may preferably be placed upon the stretcher when the rotating ring is set at 0% (percent values on the ring refer to percent pre-strain). After the film has been secured, the rotating ring may be rotated until the second prong of the two-prong guide pin reaches the desired pre-strain value. Fasteners, preferably wing nuts, may be tightened to assure the mechanism does not slip at this point, and allows for freedom of the operator's hands to place the film onto the frame. The cut-out in the center of the stretcher is designed to allow for the desired frame size, preferably 100 mm×100 mm. The contact pads may preferably be attached through the slot to a backing piece, which in turn is attached'to the pin inside of the guide on the ring.

It will be apparent to those of skill in the art that the inventive portable multipoint tenter is also scalable, thereby making it easy to redesign for any size film required. The tenter can also be adapted to have more or less pads than the eight as in the illustrated embodiment with minimal redesign. The-multi-point stretching mechanism of the present invention provides a far more even stretch than standard biaxial devices. An additional advantage derives from the device of the present invention being hand powered and thus making it portable and more environmentally friendly than current available biaxial devices which require connection to an electrical outlet.

The foregoing description of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is:

1. A portable multipoint tenter comprising:
a rotating ring with a plurality of curved slots, for placement in each of a first prong of a plurality of two-prong guide pins;
a circular base plate with a plurality of straight slots for placement of the first prong and a second prong of the plurality of two-prong guide pins; and
a contact pad attached to each of the second prongs.
